(19) United States
(12) Patent Application Publication
(10) Pub. No.: US 2017/0365023 A1
(43) Pub. Date: Dec. 21, 2017

(54) COMPUTER-IMPLEMENTED METHODS, SYSTEMS, AND COMPUTER-READABLE MEDIA FOR IDENTIFYING OPPORTUNITIES AND/OR COMPLIMENTARY PERSONAL TRAITS BASED ON IDENTIFIED PERSONAL TRAITS

(71) Applicant: SIMPLE ENTRY LLC, Baltimore, MD (US)

(72) Inventors: Elena Maria COX, Washington, DC (US); Anamaria BEREA, Rockville, MD (US)

(73) Assignee: Simple Entry LLC, Baltimore, MD (US)

(21) Appl. No.: 15/534,299

(22) PCT Filed: Dec. 8, 2015
(86) PCT No.: PCT/US2015/064390

§ 371 Date: Jun. 8, 2017

Related U.S. Application Data
(60) Provisional application No. 62/089,318, filed on Dec. 9, 2014.

(51) Int. Cl. G06Q 50/20; G06F 17/15; G06F 17/18

(52) U.S. Cl. CPC G06Q 50/2057; G06F 17/15; G06F 17/18

(57) ABSTRACT

It is an object of the invention to provide a computer-implemented method including: obtaining a data sheet including a plurality of prior participants in a plurality of opportunities, the data set including a plurality of personal attributes and a plurality of opportunity attributes; and calculating a Pearson coefficient for a plurality of pairs of personal attributes and opportunity attributes.

### CROSS-REFERENCE TO RELATED APPLICATION

This application claims priority to U.S. Provisional Patent Application Ser. No. 62/089,318, filed Dec. 9, 2014. The entire content of this application is hereby incorporated by reference herein.

### BACKGROUND OF THE INVENTION

Despite a wide variety of guides to choosing a college, college completion rates remain persistently low and transfer rates are escalating. Between 50% and 60% of students complete their four-year college degree, if given six years to do it. The other half drops out. Additionally, an escalating number of students transfer, not as a strategy, but because they find themselves questioning their first choice of college and changing mid-year freshman or sophomore year.

Families have increased the number of colleges to which their children apply and students are being accepted at more and more colleges; yet, the rate of satisfaction with the selected choice is decreasing.

The current college search and college prep market is dominated by two large non-profits, the College Board and ACT, both of which use a one-sided assessment system to pull up information from students, in the form of a test, and produce a score with no individualized feedback or useful analysis/guidance for the student beyond the score.

The current college search technologies, coaches, and cottage industry use modern technology to reach the customer, but maintain the same outdated content and keep the admissions system in control of how much families and students know and control. For example, the focus of college search engines pivot on labels that have no meaning to the consumer (drop down menus that ask teens to select Division 1, liberal arts, etc.) although these labels have no differentiating value on the actual quality or outputs for the potential buyer. Further, college search and application services measure success entirely on the hurdle of being accepted to a college, with no responsibility for whether the decision-making framework used to guide applicants to select colleges at which the student is likely to complete their studies and earn a degree.

### SUMMARY OF THE INVENTION

It is an object of the invention to provide a computer-implemented method including: obtaining a data set including a plurality of prior participants in a plurality of opportunities, the data set including a plurality of personal attributes and a plurality of opportunity attributes; and calculating a Pearson coefficient for a plurality of pairs of personal attributes and opportunity attributes.

This object of the invention can have a variety of embodiments. The computer-implemented method can further include identifying those Pearson coefficients having a positive value greater than a threshold. The computer-implemented method can further include removing those Pearson coefficients having a value greater than a threshold. The threshold can be 0.1.

The computer-implemented method can further include receiving a selection of one or more salient personal traits by a prospective participant; and for each of one or more most salient personal traits, identifying one or more opportunity traits having the highest correlation with the personal trait. The computer-implemented method can further include displaying the one or more identified opportunity traits to the prospective participant. The computer-implemented method can further include identifying one or more personal traits most highly correlated with one or more of the identified opportunity traits that were not identified by the prospective participant. The prior participants can be college students and the prospective participant can be a high school student. The prior participants can be employees and the prospective participant can be a job seeker.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIG. 1 depicts a method according to an embodiment of the invention.

FIG. 2 depicts plots of correlations of race, family income, and gender, respectively with each dimension of thriving. All plots show insignificant correlations according to an embodiment of the invention.

FIG. 3 depicts a plot of correlations of all the variables with the aggregated scores of thriving, as well as with the academic, social and happiness supra-dimensions according to an embodiment of the invention.

FIG. 4 depicts a plot of thriving across colleges in the United States according to an embodiment of the invention.

FIG. 5 depicts the distribution of distribution of predicted vs. real data differences according to an embodiment of the invention.

### DEFINITIONS

As used herein, each of the following terms has the meaning associated with it in this section.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used herein, the terms “comprises,” “comprising,” “containing,” “having,” and the like can have the meaning ascribed to them in U.S. patent law and can mean “includes,” “including.” and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 1, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

### DETAILED DESCRIPTION OF THE INVENTION

Aspects of the invention can be utilized to identify opportunities and/or complimentary personal traits based on identified personal traits. Embodiments of the invention are particularly useful for helping individuals to thrive in an environment such as a college. “Thriving” can be defined, for example, as experiencing the maximum benefits from a college eco-system and demonstrating these benefits through heightened academic and social integration and a deeper sense of happiness.

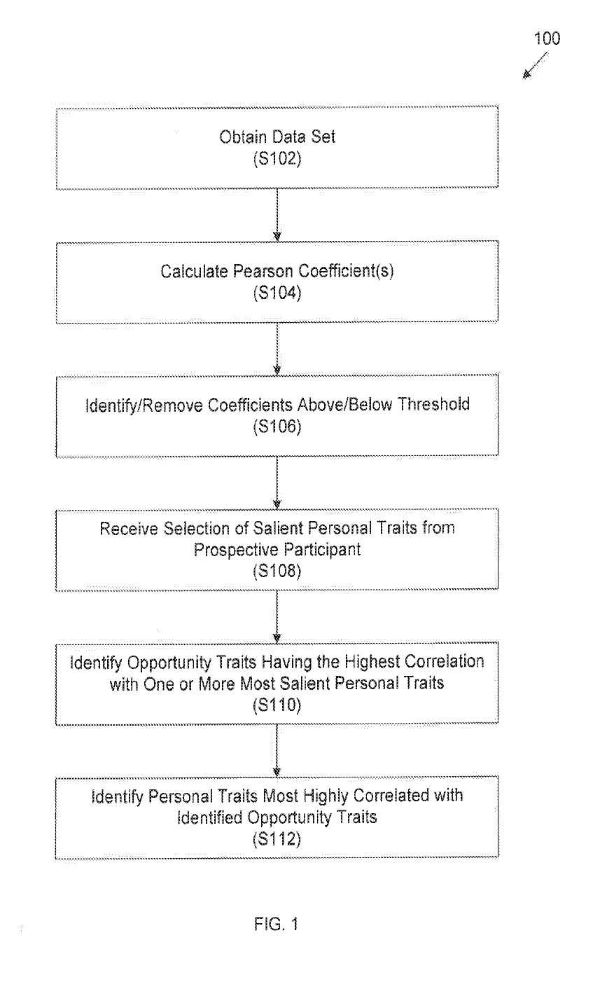

Referring now to FIG. 1, one aspect of the invention provides a computer-implemented method 100 of identifying opportunities and/or complimentary personal traits based on identified personal traits.

In step S102, a data set is obtained. The data set can include data for a plurality of prior participants in a plurality of opportunities. The data can include personal attributes and opportunity attributes. The data can be self-reported or can be meta-data generated from questions answered by the prior participants (e.g., through surveys). The data can be binary (e.g., 0 or 1, true or false, and the like), discrete (e.g., integers such as a 1-to-5 Likert scale), continuous, and the like. In one embodiment, the data set includes data gathered from surveys of current college students including questions directed toward personal attributes of the individual student and opportunity attributes about the college that they are attending or have attended. The data set can also include or can be augmented with data from other sources such as social networks.

One embodiment of the invention uses two clusters of survey questions, administered within the same survey, as its foundation. One cluster of questions asks college students to reflect on themselves as high school students. The questions in this “personal traits” section cover interests (sports, nature, travel, religion, etc.), personality traits (e.g., the so-called “Big Five” personality traits: openness, conscientiousness, extraversion, agreeableness, and neuroticism), demographics (income, race, gender), and developmental maturity (academic achievement, degree of self-motivation, degree of social integration and support). Any reasonable question that might distinguish one high school student from another can be used. In the first version of this survey, approximately 66 such individual characteristics or personal traits were queried.

In the second cluster of survey questions, the college students are asked to reflect on their experiences while at their current college campuses. Again, any characteristic that could be used to distinguish one campus from another could be used in this campus survey. In the first version of this survey, 100 distinguishing features of the college experience were probed, ranging from the clarity of loan applications, to the degree of individualized academic support, to the IT infrastructure of the university, to the student body's culture—and much more.

In addition to these two sets of questions, the students were asked 18 questions measuring how satisfied they were with various facets of their experience at their current institution. The 18 questions can be used to assign students into 4 groups: high thriving, medium high thriving, medium low thriving, and low thriving. In some embodiments, only the high thrives play a role in the final algorithm. This connects the thriving index to the subset of data used to find personal traits and campus attributes pairings. The algorithm produces the best set of pairings for students with similar traits to the user. Even without use of this “thriving data”, embodiments of the algorithm select the college traits that have higher variance for students with similar personal traits. In other words, students in the past who are like the current user, gravitated towards colleges with these traits. Whether or not those students did well at such institutions, is not expressly entered into the calculation. However, as it turns out, many of the college traits do positively influence thriving to some extent, so the feedback to a prospective student as to what similar students have done in college selection, will result in a set of college traits where each trait has some positive effect on thriving.

In step S104, a Pearson coefficient is calculated for a plurality of pairs of personal attributes and opportunity attributes. The Pearson coefficient ρ can be calculated using the formula

$${ρ}_{X , Y} = \frac{cov ( X , Y )}{{σ}_{X} {σ}_{Y}} = \frac{E [ ( X - {μ}_{X} ) ( Y - {μ}_{Y} ) ]}{{σ}_{X} {σ}_{Y}} \qquad ( 1 )$$

wherein cov is the covariance, σ_{X} is the standard deviation of X, σ_{Y} is the standard deviation of Y, μ_{X} is the standard deviation of X, μ_{Y} is the standard deviation of Y, and E is the expectation. Pearson coefficients can be calculated by using the cor function in the R programming language.

In one embodiment, a Pearson correlation matrix can be constructed. For example, using the survey discussed above, a 66 (personal trait)×100 (college trait) matrix of correlation coefficients was constructed. Most of the coefficients in the correlation matrix were close to zero, a situation shown schematically in Table 1 below. (Only 7 rows and 12 columns are depicted for ease of viewing; the actual correlation matrix would be much larger. In this embodiment, any cell with a correlation coefficient <0.1 is shown as a blank.)

TABLE 1

| | | College Traits | | | | | | | | | | | | |
|---|---|---|---|---|---|---|---|---|---|---|---|---|---|---|
| | | 1 | 2 | 3 | 4 | 5 | 6 | 7 | 8 | 9 | 10 | 11 | 12 | . . . |
| Personal Traits | 1 | | | 0.13 | | | | | | | | | 0.10 | |
| | 2 | 0.13 | | | | | 0.23 | | | | 0.22 | | | |
| | 3 | | | | | | | 0.20 | | | | | | |
| | 4 | | | | | 0.22 | | | | 0.16 | | 0.10 | | |
| | 5 | | | | | 0.14 | | | | | | | | |
| | 6 | | 0.15 | | | | 0.25 | | 0.14 | | | | | |
| | 7 | | | | 0.20 | | | | | | 0.21 | | 0.13 | |
| | . . . | | | | | | | | | | | | | |

In step S106, the Pearson coefficients can be further processed to identify coefficients greater than a defined threshold and/or to remove coefficients below a defined threshold. This threshold can user-defined or can be pre-set.

In step S108, a selection of one or more salient personal traits by a prospective participant is received. These personal traits can be identified through a plurality of questions on a survey similar to the personal trait questions used to establish the correlation matrix. This selection can be received through paper or electronic means.

For example, a prospective participant can answer personal questions as part of a standardized test or can provide such information through a computer-implemented form completed on a personal computer, tablet, smartphone, and the like. The selection can be received in a structured data format such as Extensible Markup Language (XML).

In step S110, for each of one or more most salient personal traits, one or more opportunity traits having the highest correlation with the personal trait are identified. Referring to Table 1, if personal traits 2 and 7 are identified, college traits 1, 6, and 10 are identified for personal trait 2 and college traits 4, 10, and 12 are identified for personal trait 7.

Within each of the personal traits identified, the correlation coefficients can be ranked, from highest to lowest, as shown in Table 2.

TABLE 2

| | | College Traits | | | | | | | | | | | | |
|---|---|---|---|---|---|---|---|---|---|---|---|---|---|---|
| | | 1 | 2 | 3 | 4 | 5 | 6 | 7 | 8 | 9 | 10 | 11 | 12 | . . . |
| Personal Traits | 1 | | | 0.13 | | | | | | | | | 0.10 | |
| | 2 | 3rd | | | | | 1st | | | | 2nd | | | |
| | 3 | | | | | | | 0.20 | | | | | | |
| | 4 | | | | | 0.22 | | | | 0.16 | | 0.10 | | |
| | 5 | | | | | 0.14 | | | | | | | | |
| | 6 | | 0.15 | | | | 0.25 | | 0.14 | | | | | |
| | 7 | | | | 2nd | | | | | | 1st | | 3rd | |
| | . . . | | | | | | | | | | | | | |

The strongest opportunity trait can then selected for each personal trait. Referring again to Table 2, college trait 6 can be selected because it has the highest correlation for personal trait 2, and college trait 10 can be selected because it has the highest correlation for personal trait 7. Feedback that college traits 6 and 10 are important to consider in his/her college selection can be provided to the prospective participant.

In step S112, the personal traits most highly correlated with the identified opportunity traits are identified. For example, as depicted in Table 3 below, the personal traits most highly associated with college traits 6 and 10 are identified. This results in a set of personal traits that have some overlap with the prospective participant's own personal traits. Personal traits 2 and 6 are deemed important to the selected college traits 6 and 10. Personal trait 2 was previously identified. However, personal trait 6 was not. This personal trait can be presented to the prospective participant as a personal growth area that he or she may wish to work on in order to get the more out of his/her college experience.

TABLE 3

| | | College Traits | | | | | | | | | | | | |
|---|---|---|---|---|---|---|---|---|---|---|---|---|---|---|
| | | 1 | 2 | 3 | 4 | 5 | 6 | 7 | 8 | 9 | 10 | 11 | 12 | . . . |
| Personal Traits | 1 | | | 0.13 | | | | | | | | | 0.10 | |
| | 2 | 0.13 | | | | | 2nd | | | | 1st | | | |
| | 3 | | | | | | | 0.20 | | | | | | |
| | 4 | | | | | 0.22 | | | | 0.16 | | 0.10 | | |
| | 5 | | | | | 0.14 | | | | | | | | |
| | 6 | | 0.15 | | | | 1st | | 0.14 | | | | | |
| | 7 | | | | 0.20 | | | | | | 2nd | | 0.13 | |
| | . . . | | | | | | | | | | | | | |

### Sorting of Opportunities Based on Individual Appraisals

Another embodiment of the invention presents a plurality of questions (e.g., multiple choice questions) to a user regarding the user's preferences. The user's answers can be correlated with traits related to thriving as discussed herein. The user can then be presented with questions regarding the user's perception of each of a plurality of opportunities' quality with regard to traits identified as relevant to the particular user. For example, the user can be asked to rank a plurality (e.g., 3) of opportunities (e.g., colleges) for each trait. The user's scoring can be then be used to provide an assessment of each opportunity. For example, each 1st ranking for a trait can be worth 3 points, each 2nd ranking for a trait can be worth 3 points, and each 3rd ranking for a trait can be worth 1 point. The scores for each opportunity can be summed and presented graphically (e.g., in a chart).

### Analysis of Participant Traits Increasing Probability of Thriving in Opportunity

Embodiments of the invention can be adapted to solve for correlations between individual participant (e.g., student) traits and an opportunity (e.g., college) ecosystem that, when paired, increase probabilities of each individual thriving and completing. Such embodiments can be marketed to colleges. Colleges can provide the results and suggestions to students along with coaching to develop traits that would increase thriving.

Implementation in Computer-Readable Media and/or Hardware

The methods described herein can be readily implemented in software that can be stored in computer-readable media for execution by a computer processor. For example, the computer-readable media can be volatile memory (e.g., random access memory and the like) and/or non-volatile memory (e.g., read-only memory, hard disks, floppy disks, magnetic tape, optical discs, paper tape, punch cards, and the like).

Additionally or alternatively, the methods described herein can be implemented in computer hardware such as an application-specific integrated circuit (ASIC).

Embodiments of the invention can be utilized to generate various customized content based on analysis of a user's input. For example, embodiments of the invention can generate a customized webpage, zine, on printed matter discussing traits that the user demonstrates, should develop, and/or should seek in an opportunity.

### Working Example

### Methodology

### Data Collection

An online quantitative survey was conducted using Research Now's online consumer panel. To qualify for the survey, potential respondents had to be ages 18-24, living in the U.S. before entering college, and either in their sophomore, junior or senior year at a postsecondary four-year institution or graduating within the past two years. Those obtaining their postsecondary instruction completely or mostly online were terminated, as were those who transferred or dropped out for financial reasons or external factors and those who attended two or more institutions but did not obtain their college degree. Shortly after the start of interviewing, these qualifiers were altered slightly to allow in those who had last attended college within the past four years and had not graduated, as well as transfer students who had graduated within the past four years. The purpose of these changes was to include more individuals who were not a good fit with their choice of schools. Finally, quotas were set by race/ethnicity to ensure adequate representation for analysis.

The questionnaire included in the instrument covered: satisfaction with their college experience; college attributes including distance from home, student types, course of study and teaching methods, learning resources, preparation for the real world, student athletics and fitness, rules and structure, dorms, finances and other dimensions; respondent character traits and academic performance with a particular focus on what the student was like in high school; and pricing for the online tool. When answering questions about their college experience and college attributes, transfer students were asked to focus on the first college they attended. A series of questions was also asked to gather demographic characteristics, such as sex, age, race/ethnicity and family income. Six cognitive interviews were conducted before finalizing the questionnaire.

The interviews lasted an average of 25 minutes. Several methods were used to keep the respondents engaged and the majority found the survey experience extremely or very enjoyable. The large majority were able to keep their concentration on the survey questions and the median perceived elapsed time was only 20 minutes.

In total, 2,857 respondents were interviewed and included in the final data set. The data set was weighted by race/ethnicity and gender to match the distribution of these characteristics among 19-24 year-olds with at least some college in the U.S. population based on the March 2012 Current Population Survey. Data on college characteristics from the Integrated Postsecondary Education Data System (IPEDS) was merged into the data file. This resulting data set constituted a robust body of data for subsequent steps of the research process. The institutional characteristics included in the survey were obtained from U.S. Department of Education Institute of Education Sciences National Center for Education Statistics Integrated Postsecondary Education Data System (IPEDS) and includes both basic institutional demographics (type, size, control, average net price), and unique institutional characteristics that may facilitate thriving generally (Carnegie classifications) and for specific sub-populations of students (i.e., women's colleges, historically black colleges and universities (HBCUs), religious affiliated colleges). Applicant consulted three main sources to conceptualize institutions differently: (1) the most recent version of the Carnegie Classification System for Colleges and Universities, (2) George Kuh's characterizations of Project DEEP Schools at G. D. Kuh, “The national survey of student engagement: conceptual framework and overview of psycho-metric properties” (Technical report, Indiana University, 2004), and (3) the Integrated Postsecondary Education Data System (IPEDS) available at https://nces.ed.gov/ipeds/datacenter/. Some of the Carnegie classification data are included in the IPEDS system and are accessible to categorize institutions.

An emphasis of the study was to identify the characteristics of colleges and universities that may facilitate or impede a student ability to thrive rather than a list of actual institutions.

The personal characteristics included in the survey included psychological traits (e.g., “ambitious”, “extroverted”), academic performance in high-school (e.g., “hard-working”, “completed projects”), economic and demographic characteristics (e.g., family income).

For each of these questions, the respondents answered on a 1-7 Likert scale. The data collected and used for the analysis consists of 605 variables, grouped as follows: demographic variables, economic variables, geo-spatial and transportation variables, high-school experience variables, behavioral variables, college campus variables and psychological traits variables.

### A Quantitate Multi-Dimensional Concept of Thriving

Additionally, the survey asked the students whether they considered themselves as thriving in college or not based on 18 questions (dimensions of thriving) related to academic, personal happiness, and social integration.

One of the goals of the survey was to find linkages between student characteristics and college characteristics that could then be used to predict thriving, based on self-reporting of the respondents regarding their own perception of thriving in college. In order to guard against self-reporting bias regarding thriving, Applicant conceptualized thriving in college based on the 18 dimensions listed in the Appendix to this application.

### Data Analysis

### Effect of Demographic Variables

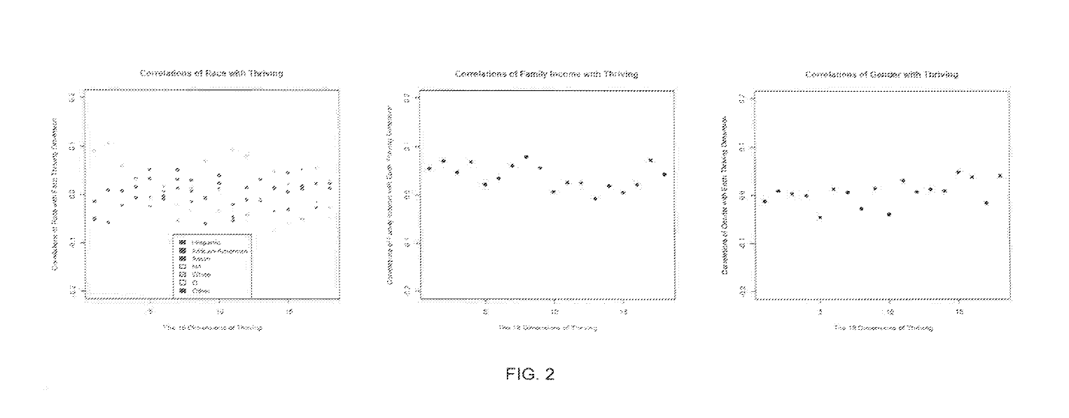

First, Applicant analyzed the data collected from the survey in order to find if there are any correlations of thriving with race, gender or family income, on each of the 18 dimensions of thriving. Applicant found no significant correlations or relationship between these demographic variables and thriving as depicted in FIG. 2.

### No General Prediction of Thriving

After eliminating any demographic variables as potential predetermined factors for thriving, Applicant also tested whether any of all the other variables-personal traits and college traits—are correlated with thriving.

In order to do this, Applicant looked not only at the pairwise correlations of the each of the other variables with the 18 dimensions of thriving, but also at an aggregate measure of thriving based on 3 supra-dimensions: academic, social and happiness. The aggregation of the 18 thriving dimensions into 3 supra-dimensions was based on an exploratory factor analysis using the principal components method and calculates an overall raw score based on the following derived formulas:

rawacademicthrivingscore=(0.522*Q3d)+(0.539*Q3g)+(0.692*Q3h)+(0.624*Q3i)+(0.648*Q3j)+(0.671*Q3k)+(0.611*Q3l)+(0.676*Q3m)+(0.651*Q3n)+(0.579*Q3p) (2)

rawsocialthrivingscore=(0.519*Q3a)+(0.757*Q3b)+(0.785*Q3c)+(0.557*Q3d)+(0.636*Q3e)+(0.756*Q3f)+(0.548*Q3o) (3)

rawhappinessthrivingscore=(0.771*Q1)+(0.881*Q2)+(0.636*Q3a)+(0.644Q3g)+(0.639*Q3o) (4)

where Q1 . . . Q3p are each of the 18 thriving dimensions described in the Appendix. Based on these aggregated 3 scores, Applicant calculated the aggregated raw overall thriving score by normalizing the above 3 raw scores, as follows:

rawoverallthrivingscore=(0.24819*rawacademicthrivingscore)+(0.21833*rawhappinessthrivingscore)+(0.21601*rawsocialthrivingscore) (4)

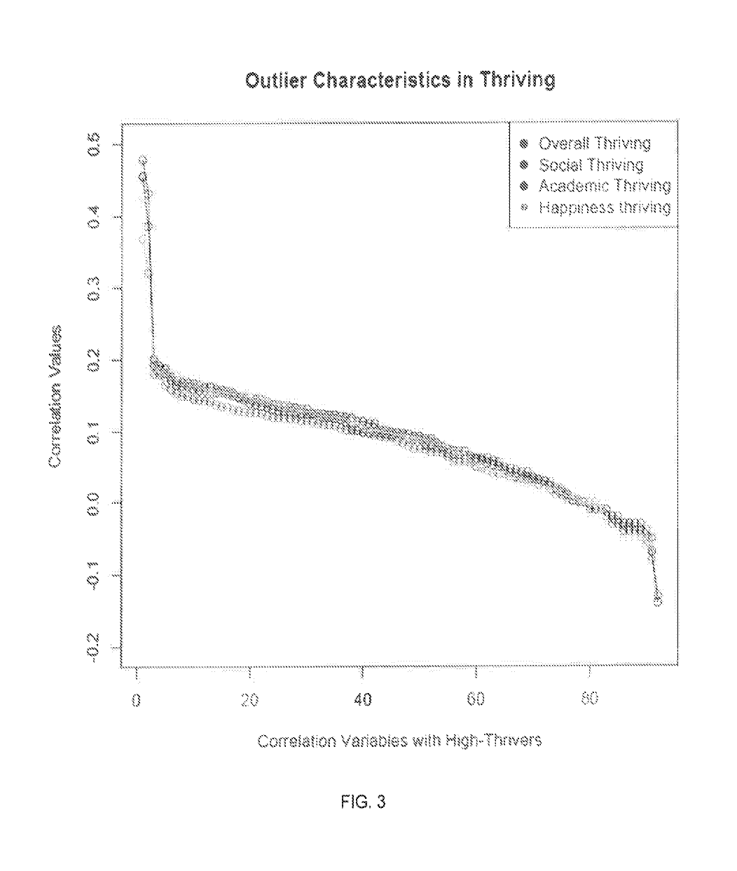

FIG. 3 shows that the correlations between an aggregated dimension of thriving (rawoverallthrivingscore) and all the other variables in the data set are insignificant. Applicant also calculated correlations of all the other personal and college traits variables with each of the 18 dimensions of thriving, without any significant results and also we performed a k-cluster analysis in order to identify those clusters of variables, particularly college variables, that are predictive to thriving.

All these analyses proved that there is not one single variable that is significantly correlated with thriving. The analyses above were performed by 3 independent teams and show that both the student and the college universes are very diverse and heterogeneous and that aggregating the data and looking for general patterns does not render any variable for predicting thriving.

### Application of Algorithm

### Description of Algorithm

Exploratory data analysis shows that student thriving in the US colleges is not determined by any general personal characteristic of students (such as academic scores or extroversion in high school) or by any general characteristic of college (such as technology on campus or campus size). Based on the data analysis above, Applicant hypothesized that there is no general pattern that is a good predictor for thriving in college.

This means that students and colleges should be treated individually, not aggregately, and that a recommending algorithm should be able to assign specific and unique college traits (a unique college ecosystem) to specific and unique individual traits (an unique student).

Applicant built a personalized algorithm that matches various combinations of personal traits with various combinations of college traits, i.e., college ecosystems, and ranks them according to the best chances of thriving, thus rendering the best college ecosystem that fits any given individual. The algorithm answers the question: which combination of college traits gives the best predictability of thriving for a given combination of personal traits, on a case by case situation, for one person?

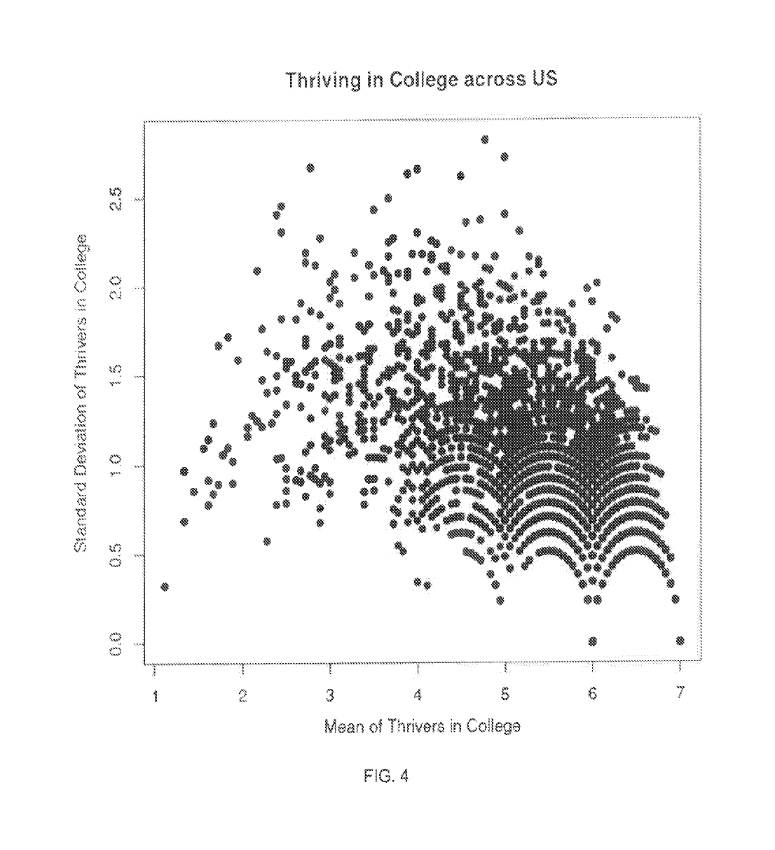

Applicant separated the data set into “high thrivers” and “no thrivers” based on a mean above 5 and a standard deviation below 1. FIG. 4 shows how the high thrivers in the United States are clustering and the low thrivers in the United States are dispersing in their thriving on all 18 dimensions.

Only two sets of information: the personal traits survey data (variables Q33 through Q42) and the college traits survey data (variables Q0 through Q28), are used to construct the algorithm. With these, a pairwise Pearson correlation matrix is constructed. This matrix is a 66 (personal trait)×100 (college trait) dimensions of correlation coefficients.

Taking into account only the subsetted correlation matrix for “high thrivers”, Applicant examined any combination of personal traits and ranked the correlations with the college traits for each of the personal traits variable, from the highest value to the smallest value. The strongest college trait is then selected for each student trait.

In this way, for each input combination of personal traits, the algorithm renders an output combination of college traits that has the highest ranked correlation with each input variable. This combination of college traits forms the college ecosystem where that respective individual is more likely to thrive.

Moreover, the algorithm can identify which personal traits the individual may wish to develop or emphasize, in order to enable her to get even more benefit out of the same collegiate institution.

### Implementation of Algorithm

### A. Selection of the Data for High-Thrivers Based on Mean and Standard Deviation Thresholds.

First, calculate the mean and standard deviation of the 18 dimensions of thriving for each of 2857 students in the data:

```
mea <- mean(as.numeric(thrivingdata[1,]))
sta <- sad(as.numeric(thrivingdata[1,]))
for(i in 1: 2857){
    mea[i] <- mean(as.numeric(thrivingdata[i,]))
    sta[i] <- sd(as.numeric(thrivingdata [i,]))
}
```

Referring to FIG. 4, the plot of the mean and standard deviations of the students shows an interesting clustering effect of the high-thrivers and the sparsity of the low-thriver. Based on this, Applicant selected a subset of high-thrivers as the students with the mean above 5 and the standard deviation below 1:

```
    topthriving <-
mydata[which(rowMeans(mydata[1:18]) >
    5&rowSds(as.matrix(mydata[1:18]))<1),]
```

### B. Computation of Pairwise Correlation Matrix

Second, Applicant calculated the pairwise correlations between the college factors and the personal factors for high-thrivers:

Ptocollege <- cor(collegedata, personaldata)
N <- as.matrix(cor(collegedata, personaldata))
for(i in 1:length(colnames(personaldata))){
N[,i] <- rownames(Ptocollege[
order(as.numeric(-Ptocollege[,i])),])
}

Third, Applicant either transposed the matrix N above or correlate the personal factors with the personal factors for high-thrivers and store it in a separate data frame:

Ctoperson <- cor(personaldata, collegedata)
P <- as.matrix(cor(personaldata, collegedata))
for(i in 1:length(colnames(collegedata))){
P[,i] <-
rownames(Ctoperson[order(as.numeric(-Ctoperson[,i])),
])}

### C. The Outputs of the Algorithm:

The user chooses the personal traits from the list of questions from the data that she feels are the best personal description. The selection for the input is made by the user from questions Q33-Q42 in the data. For example:

input < -c(“Q34A”, “Q34C”, “Q34E”, “Q37F”)

The algorithm searches for the highest correlation with each of the input variable among the Q10-Q28 questions in the data, as described below.

### C.1. A Unique College Ecosystem for Each Student

Applicant ordered decreasingly and selected the best college trait for each personal trait:

bestcollegetraits < -order(as.numeric(-N[ ,] ))

Applicant selected the top college trait for each of the personal trait and clustered them together into the college ecosystem. Applicant printed the actual names of the variables (e.g., “campus that is technologically advanced, campus that is close to outdoors, etc.”):

collegeecosystem <- as.data.frame(bestcollegetraits)[
input] [ 1, ]
ecosystem <- as.vector(t(collegeecosystem))
mycollege <- t(variablesnames[ ecosystem] )[ , 2]
mycollege

Output mycollege is a unique set of college characteristic—the college ecosystem—corresponding to the unique set of input. This college ecosystem is the best ranked college ecosystem out of any other possibilities that will help the student thrive.

### C.2. The “Ideal Student” for an Input of College Traits

The input here is the college ecosystem mycollege above. Separately from the individual choice above, Applicant can use as input any set of college traits (Q10-Q28) when seeking to identify the “ideal student” for a different college eco-system.

Applicant ordered decreasingly and selected the best personal traits for each college trait:

bestpersonaltraits < -order(as.numeric(-P[ ,] ))

Applicant selected the top personal trait for each of the college traits and clumped them together into the makeup of the “ideal student”. Applicant printed the actual names of the variables (e.g., “student that is extrovert, student that participates in varsity sports”, etc.):

optimaltraits <- as.data.frame(bestpersonaltraits)[
input] [ 1, ]
personality <- as.vector(t(optimaltraits))
mystudent <- t(variablesnames[ personality] )[ , 2]
mystudent

The output mystudent is a unique set of personal traits—the “ideal student”—that is most likely to be thriving in this college eco-system.

C.3. The Characteristics that the Student should Enhance and Those he should Acquire in Order to Increase his or her Chances of Thriving

The algorithm can also print the additional traits the student should does not currently possess but should obtain, as the difference in traits between the “ideal student” and the current student:

optimiz <-
as.vector(t(as.data.frame(bestpersonaltraits)[
ecosystem] [ 1, ] ))
newtraits < -setdif f (input, optimiz)
ntraits < -t(variablesnames[ newtraits] )[ , 2]
ntraits

Similarly, it can output which current traits the student should enhance, namely those common traits between the “ideal student” and the current user:

besttraits <- intersect(input, optimiz)
btraits <- t(variablesnames[ besttraits] )[ , 2]
btraits

The algorithm matches the combinations of individual traits and college ecosystems bidirectionally; it can also be a recommender for colleges about the student traits that are more likely to thrive under their ecosystem. And by intersecting the input from C.1. input with the output from C.2. my student, those characteristics that are more likely to help a student thrive in the college environment of their choice can be identified, distinguishing between those he has and should enhance versus those he should obtain.

### Results and Discussion

### Predictive Power and Validation

Currently our algorithm is based on the variables and correlations from the survey. In order to calculate its predictive power, Applicant used A|B testing and randomly split the data in 2 data sets for training and testing.

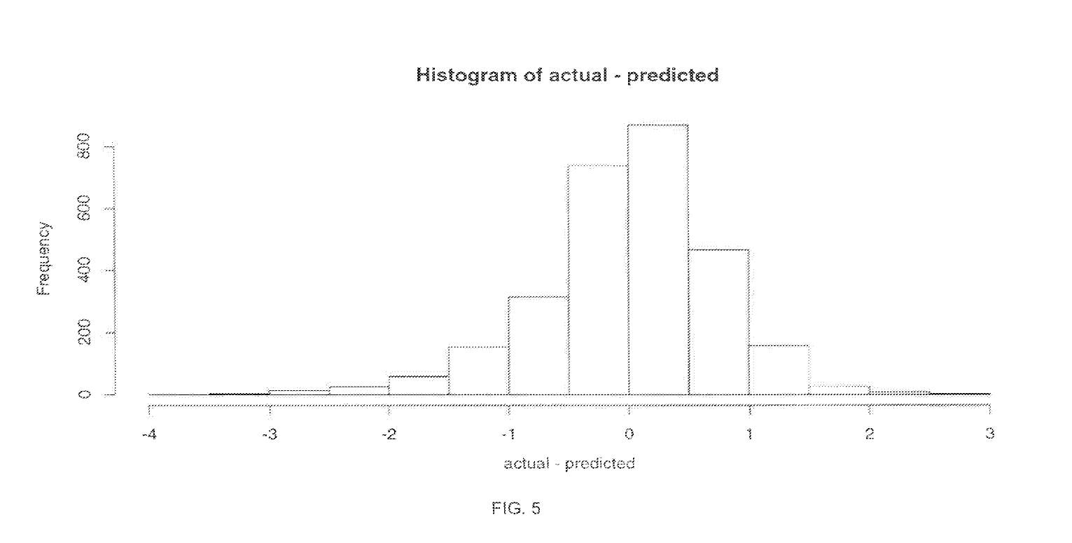

For the same input of personal traits, randomly sampled from sets of min 3 to max 66 personal traits, the college ecosystem output shows a predictive power of 53% for exact matching of output college ecosystem traits, a predictive power of 56% for 90% matching in outputs of college ecosystem traits (meaning that there are 10% traits that do not match exactly between the training and testing data) and a predictive power of 88% for 80% matching in outputs of college ecosystem traits. FIG. 5 shows the differences in the values between the actual data and the predicted data for exact matching. The predictability errors follow a Bell curve distribution.

The algorithm shows that predicted values tend to be slightly optimistic, but not significantly.

The algorithm is currently implemented into a commercial digital product. Applicant will be able to collect data from the real users and assess the commercial validity and customer satisfaction of the algorithm.

The richer the selection of variables in the input is, the more refined and unique the combinations of outputs are and the higher the predictability of the outputs.

### Algorithm Applications, Examples and Extensions

Embodiments of the algorithm can combine 66 personal traits into groups of 1, 2, . . . 66; this means that the algorithm can create 6.45146 “persons” with different psychological traits in the lab. Additionally, it can show which of the current traits of the student are more likely to lead to her thriving in the recommended college ecosystem. It can also show which of the traits the student does not have, but are also desirable to her specific college ecosystem.

Applicant asked several prospective college students to pick a set of personal traits and provided the students with the characteristics of a thriving college ecosystem, the strengths they have, and the traits they should develop. For example, John picked as his personal traits the following: need for solitude, caring and supportive, self-centered, artsy and creative, calm and emotionally stable and hard working. The best college ecosystem for him is one who is academically rigorous, encourages students to meet new people, has a student body that is self-centered, easy going and creative and where the campus is not well connected with places of interest.

On a case by case study, Applicant tested the algorithm on approximately a dozen students. For example, some of the unexpected thrivers thrive on campuses where there are outdoor activities, there are off campus distractions but also there is a lack of transportation to go off campus. Perhaps these are the students who are confined to campus, but have the outdoor activities as an outlet and also have all the resources they need on campus to keep them focused. And the expected thrivers would thrive on campuses that have inclusion, by perhaps being exposed to other students than just those like themselves. Another way to understand this is that unexpected thrivers would thrive better in campuses where they have different activities in one place (the actual logistical space is more important), while for the expected thrivers it is about being exposed to various people and students (the social possibilities are more important).

### CONCLUSION

The data analysis, when looking at the general effects, shows that there is no variable that distinctively influences thriving, whether these variables are demographic or personal traits. If there is no general trait or demographic that someone should possess in order to thrive, every person can be treated differently and assess based on their unique makeup. Embodiments of the invention provide a unique assessment by ranking the correlations of each personal trait with each college trait and selecting only the top-ranked traits. In other words, embodiments of the invention provide a tool that helps organize low effects into ecosystems with the best likelihoods of thriving, by using a highly personalized approach.

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

### APPENDIX

### Dimensions of Thriving in College

Q1 How satisfied are you with your overall experience attending college?
Q2 How would you evaluate your choice of college?
Q3a How well does the following describe your experience at your college: you feel/felt you belong(ed) there?
Q3b How well does the following describe your experience at your college: You can/could find support from friends, if you need(ed) it?
Q3c How well does the following describe your experience at your college: you are/were satisfied with the number of friendships you have/had?
Q3d How well does the following describe your experience at your college: outside the classroom itself, you have/had people you look(ed) up to?
Q3e How well does the following describe your experience at your college: you enjoy(ed) involvement in non-academic student organizations?
Q3f How well does the following describe your experience at your college: you have/had plenty of good times outside of class?
Q3g How well does the following describe your experience at your college: your academic experience is/was satisfing?
Q3h How well does the following describe your experience at your college: you have/had academic discussions with faculty outside of class?
Q3i How well does the following describe your experience at your college: your classes are/were exciting to you?
Q3j How well does the following describe your experience at your college: your college experience is helping/helped you develop intellectually?
Q3k How well does the following describe your experience at your college: your college experience is helping/helped you learn to be more creative?
Q3l How well does the following describe your experience at your college: your college experience is helping/helped you become comfortable talking about your ideas with others?
Q3m How well does the following describe your experience at your college: college is helping/helped you learn how hard you can work to achieve a goal?
Q3n How well does the following describe your experience at your college: college is helping/helped you acquire concrete skills that are useful in the real world?
Q3o How well does the following describe your experience at your college: you are/were happy with life in college?
Q3p How well does the following describe your experience at your college: your college experience is helping/helped you develop as a person beyond academics?

1. A computer-implemented method comprising:
obtaining a data set including a plurality of prior participants in a plurality of opportunities, the data set including a plurality of personal attributes and a plurality of opportunity attributes; and
calculating a Pearson coefficient for a plurality of pairs of personal attributes and opportunity attributes.

2. The computer-implemented method of claim 1, further comprising:
identifying those Pearson coefficients having a positive value greater than a threshold.

3. The computer-implemented method of claim 1, further comprising:
removing those Pearson coefficients having a value greater than a threshold.

4. The computer-implemented method of claim 2 or 3, wherein the threshold is 0.1.

5. The computer-implemented method of claim 1, further comprising:
receiving a selection of one or more salient personal traits by a prospective participant; and
for each of one or more most salient personal traits, identifying one or more opportunity traits having the highest correlation with the personal trait.

6. The computer-implemented method of claim 5, further comprising:
displaying the one or more identified opportunity traits to the prospective participant.

7. The computer-implemented method of claim 5, further comprising:
identifying one or more personal traits most highly correlated with one or more of the identified opportunity traits that were not identified by the prospective participant.

8. The computer-implemented method of claim 5, wherein:
the prior participants are college students; and
the prospective participant is a high school student.

9. The computer-implemented method of claim 5, wherein:
the prior participants are employees; and
the prospective participant is a job seeker.
